(19) United States
(12) Patent Application Publication
(10) Pub. No.: US 2003/0205152 A1
(43) Pub. Date: Nov. 6, 2003

(54) System and method for corner stenciling

(76) Inventor: Sala Davis Houtzer, Goldsboro, NC (US)

Correspondence Address: Tiffany Delisio, 1734 P St NW #4, Washington, DC, 20036, US

(21) Appl. No.: 10/135,390

(22) Filed: May 1, 2002

(51) Int. Cl. B41L 13/00; B05C 17/06

(52) U.S. Cl. 101/127

(57) ABSTRACT

A wall corner stencil design system and application method that resolves design impasses unique to the corners of rooms by converting wall corners into focal points for visual and aesthetic design continuity with the incorporation of “stop-gap stencils” and/or a “corner stencil” (consisting of “left” and “right” sides) designed for independent use and to compliment existing and/or underlying running border stencil patterns.

### FIELD OF THE INVENTION

The present invention relates to the creation of an aesthetic design method and application solution for wall corners included in the stencil area generally treated by running border stencil designs.

### BACKGROUND OF THE INVENTION

The existing field of wall stencils offers no comprehensive, aesthetic design solution for “turning the corner” in a room. A person skilled in the art, also the artist employing stencils to create a certain ambience or aesthetic, is typically confronted with stencil art that stops abruptly at or near the wall corner, leaving the viewer with a sense of imbalance resulting from the “unfinished” design concept. Other running border stencils continue awkwardly through the wall corner without any design adjustments or accommodations addressing the visual skew presented by the 90-degree angles it crosses at each wall corner.

A number of patents such as U.S. Pat. No. 4,023,488 issued to Zimmer, U.S. Pat. No. 4,313,503 issued to Perra, Jr. et al, and U.S. Pat. No. 5,894,794 issued to Imamaki include machinery enabling stencil printing on various surfaces or forms, but these were not contemplated for use on wall surfaces, therefore the relevant field remains open for development.

One invention found in the art was a stencil set for decorative window trim, U.S. Pat. No. 5,460,087, issued to Ogorzalek, which included a temporary stick adhesive to assist in attaching the stencil template to an irregular surface such as a window frame, however this did not contemplate “turning a corner” and the stenciling complications arising thereon, therefore the relevant field remains open for development.

A public domain search did not reveal any “suites” of stencil designs or comprehensive solution that affectively addresses the wall corner design complications that arise with the application of border stencils. One example of a mirror-image, bookend-type stencil was found in a catalogue and is attached hereto¹, however this method is not a viable wall corner design solution for most running borders, it does not address bridging rather than bracketing the centerline which occurs at the midpoint of the wall corner, it provides no transitional break from the running border stencil to the wall corner nor does it contemplate use of asymmetrical corner stencils. ¹ Source: Stenciler's Emporium Inc. catalog, architectural stencil, “plumes petite” corners.

A public domain search did reveal a method consisting of “stringing together” repeat images found in a running border design with a series of painted connectors appearing like “strings or ropes”. These curvilinear “strings or ropes” which are added to the underlying design can either be incorporated throughout the length of the running border design or applied only where the stencil pattern ceases or is disrupted at or near the ends of each wall² on either side of each wall corner. Although any border stencil can incorporate a series of similar curvilinear lines to bridge two sides of a wall corner, this solution is merely a superficial attempt to camouflage the inherent design defect arising at wall corners and not always appropriate to the aesthetic of the design. Additionally, this solution does not anticipate the difficulties that arise when modifying an existing stencil template to “turn a corner” and the stenciling complications arising thereon, therefore the relevant field remains open for development. ² An example of this effect can be viewed at www.stencilgirl.com.

Those skilled in the art recognize that border stencils are designed to run along the top of a wall. A person using a border stencil is often disappointed with disjointed outcomes in the wall corners despite attempting to calculate distances, placement and spacing and other efforts to minimize optical disparities at those junctures. Although posing distinct design complexities the consideration of “turning the corner,” when applying a running border stencil, has not been addressed separately in prior art with a comprehensive stenciling solution able to accommodate visual complexities and surface irregularities (that increase the likelihood of paint slippage beneath the stencil template) on the two sides of the wall corners. Therefore there is a need for a corner stenciling system and method of implementation that anchors the base design/running border stencil, minimizes paint application errors, and enhances the overall visual continuity of the art.

The present invention evolved because cutting, folding or otherwise using a portion of the base running border stencil to resolve wall corner disparities is generally not a desirable solution. Typically, the base stencil template and/or portion thereof is not designed to work with the optical complications and possible joint and drywall irregularities arising in a corner and the end result could be a sloppy, smeared hodgepodge needing adjustments that never quite do the trick and/or which may ultimately become an eyesore that detracts from the rest of the stencil and/or room décor for that matter. Furthermore, folding or cutting a stencil template in half (or at a self-selected fold or crease) results in a debilitating loss of the image and/or design components which can be distorted or destroyed in the creasing and/or cutting which may be necessary to attach the stencil template as flatly as possible in the first place.

The present invention provides an independent corner stencil template solution consisting of a “stop-gap” and/or a “corner stencil” (consisting of “left” and “right” sides) designed to bracket and compliment existing running border stencil patterns and minimize the need for often fruitless endeavors to calculate distances, placement and spacing solutions which a person skilled in the art generally attempts in order to minimize potential visual flaws. Creating a “corner stencil template” with two independent sides enables the person skilled in the art to adjust the template to fit as flatly on the wall surfaces as possible without concerns for the folded/creased portion of a “whole template”. The object of this invention is to provide a corner stencil design system and application method that substantially resolves or improves the design and application impasses unique to the corners of rooms by creating visual continuity without compromising the design integrity of the underlying running border stencil.

### SUMMARY OF THE INVENTION

When persons skilled in the art apply running border stencils to walls, they commonly experience aesthetic and application complications (such as an unbalanced break or loss of design integrity at the centerline/wall corner due to irregular surfaces which frequently result in artistic flaws in the visual continuity of the overall design intentions) that arise when a border stencil template is repeated and continued across wall corners. The present invention resolves this widespread aesthetic and application conundrums by applying “stop-gap stencil(s)” and/or a “corner stencil with left and right sides” (both stylistically adapted to reflect elements derived from the existing/underlying running border aesthetic) to anchor the base design/running border stencil both aesthetically and spatially. More specifically, the present invention provides a novel and non-obvious corner stenciling method that employs two complimentary stencils (left and right side halves, not necessarily symmetrical, which are placed at either side of the wall corner and cohere as a complete object), designed to maintain independent structural integrity when used sequentially as cohesive counterparts to create an element or design on a wall or other appropriate surface featuring one or more corners within the design space.

A person skilled in this art may choose to use the “stop-gap stencils (generally, mirror image)” and corner stencil separately and/or in combination to achieve the desired wall corner design resolution appropriate to the underlying stencil aesthetic and/or theme. The “stop-gap” resolves and/or terminates the base design (also referred to as a running stencil) at the beginning and end of each “run” by effectively “book-ending” the base design, thus creating a “pause” in the running border near the edges of the wall in proximity to each wall corner. The remaining space in the wall corner should be sufficient to place the primary element of this invention, the “corner stencil with left and right sides” (designed to incorporate some or all of the design elements in the base stencil used as the running border art) which “anchors” the border stencil design in a visually satisfactory manner previously unachieved by using the standard running border stencil or portions thereof alone.

Another embodiment of the “stop-gap stencils” contemplated in the present invention can reflect elements found in the underlying running border stencil or introduce a complimentary design element which effectively terminates the border stencil as it approaches the wall corner, allowing for a stylized transition and pause before the optional introduction of a corner stencil.

An embodiment of the “corner stencil” in the present invention may be constructed from two complimentary, but not necessarily symmetrical, “halves” which, when properly matched and used as the template for paint application, successfully result in a visual “whole.”

As the present invention suggests, a person skilled in the art can create his/her own left and right corner stencils and stop-gaps by extracting and/or incorporating one or more elements featured in the underlying border stencil to make new, complimentary stencils. Such stencils should be designed to enable a visual transition from the base stencil as applied on the wall to the “stop-gap stencils” and/or corner stencil which ultimately anchor the rest of the design.

The solitary and/or combined use of the wall corner stenciling elements comprising the present invention, which include the “stop-gap” and left and right “corner” stencils, has utility in that they provide novel, non-obvious alternatives for resolving the design and painting intricacies generally sustained when “turning the corner” in stenciling.

### BRIEF DESCRIPTION OF THE DRAWINGS

FIG. 1 is a possible embodiment of a repeating, running border stencil as it breaks asymmetrically across a wall corner.

FIG. 2 is a possible embodiment of the present invention featuring left and right sides of a corner stencil, with placement of stop-gap stencils (mirror images) and portions of the base (running border) stencil on the wall extending therefrom.

FIG. 3 is another possible embodiment o the present invention featuring a symmetrical corner stencil placed on a wall corner, with placement of left and right stop-gap stencils (mirror images) and portions of the base (running border) stencil on the wall extending therefrom.

FIG. 4 is a possible embodiment of an asymmetrical corner stencil, with placement of left and right stop-gap stencils (mirror images) and portions of the base (running border) stencil on the wall extending therefrom.

### DETAILED DESCRIPTION OF THE PREFERRED EMBODIMENTS

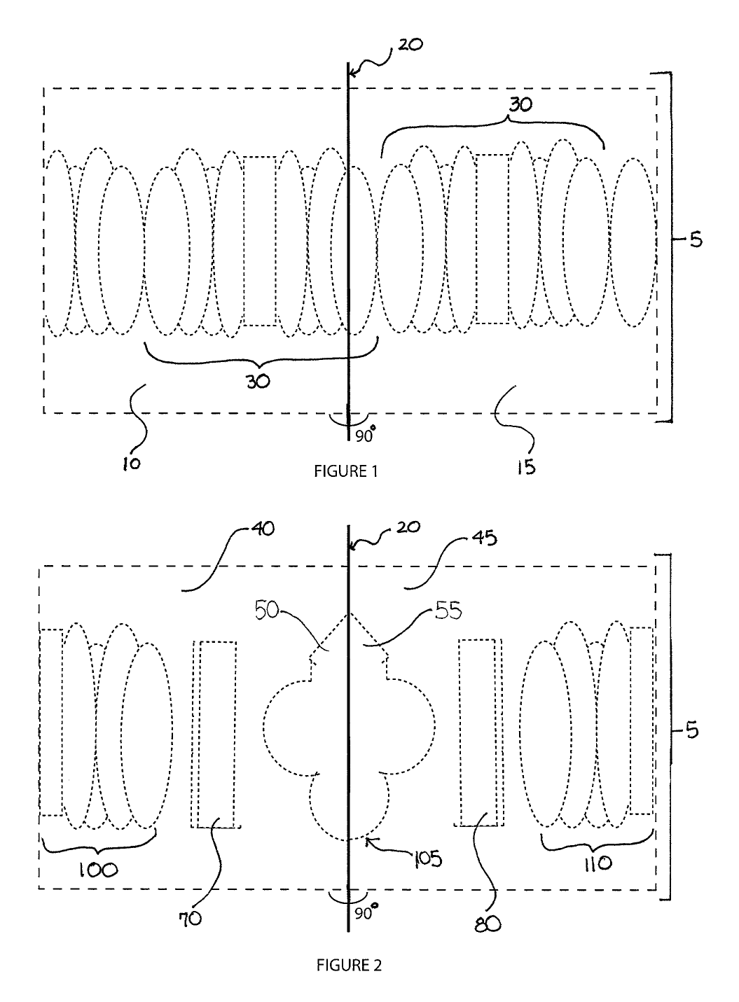

FIG. 1 shows a diagram of two sides of wall corner 5, left and right sides 10 and 15, with centerline 20, featuring a repeating, running border stencil 30 as it breaks asymmetrically across centerline 20, a scenario that typically occurs when a person skilled in the art repeats the running border stencil over the wall surface of a room without incorporating a separate, anchoring treatment for the wall corners included within the stenciled area.

FIG. 2 shows a diagram of two sides of a wall corner 5, left and right sides 40 and 45, with centerline 20, featuring an embodiment of the present invention including a corner stencil 105 with left and right sides 50 and 55 (that match up at centerline 20) with stop-gap stencils (mirror images) 70 and 80 which serve as an anchor and transitioning pause for the base stencil extending therefrom on both sides 100 and 110. Note how the stop-gaps 70 and 80 can reflect an element common to the base stencil 100 and 110 (in this instance a rectangular shape), while the corner stencil has a shape not common to the base stencil; however, both the stop-gap stencils (mirror images) 70 and 80 and corner stencil 50, can incorporate design and thematic elements of the base stencil 100 and 110 as determined by the discretion of the person skilled in the art.

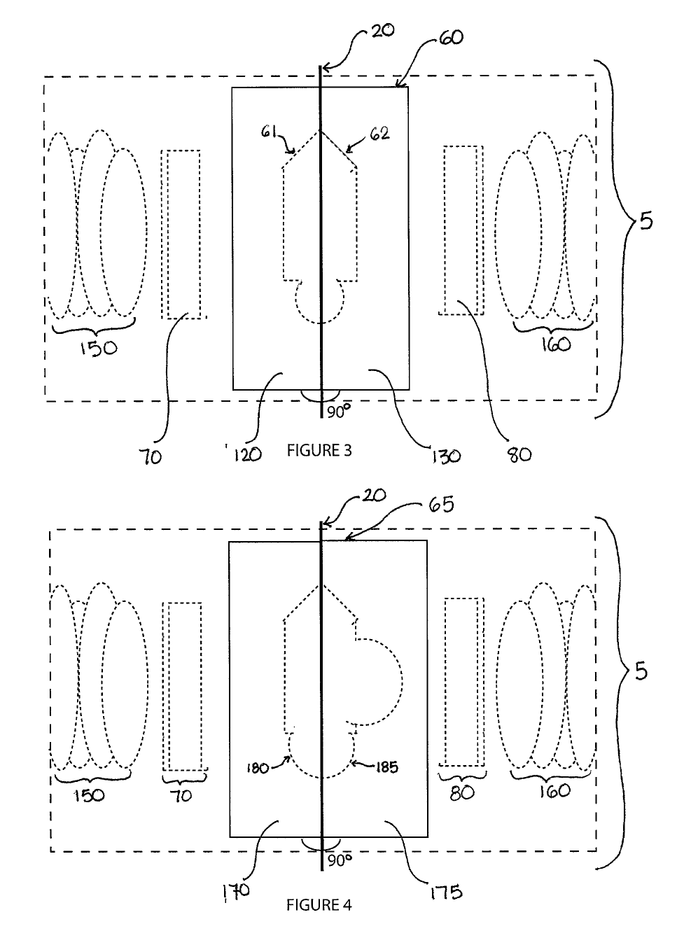

FIG. 3 shows a possible embodiment of a symmetrical corner stencil 60 with left and right sides 120 and 130 as it breaks across the centerline 20. Note how the stencil 60 is cut out (61 and 62) on either side of the centerline 20. Creating the stencil in two structurally intact halves, which combine in application to create a cohesive whole, eliminates the possibility of a loss of stencil design integrity when applied to a corner surface. Such a dilemma commonly occurs when a person skilled in the art, or other artist, attempts to convert a running border stencil into a corner stencil by folding, cutting, creasing and/or otherwise distorting and conforming the stencil into a position bridging a wall corner 10 with centerline 20. Performing any of the activities referenced in the preceding sentence can result in lost, clipped and/or misshapen elements of the original stencil because it will not lie flat.

Although the embodiments of the stop-gap stencils (mirror images) 70 and 80 and base running border stencils extending therefrom on either side (mirror images) 150 and 160 are shown here in FIG. 3, this image is not to scale and inclusion of these elements are for demonstrative purposes only. Typically the wall corner stencil halves, the stop-gap stencils and the base/running border stencil will be separate pieces of the design series.

FIG. 4 shows a possible embodiment of an asymmetrical corner stencil 65 with left and right sides 170 and 175 as it matches up at centerline 20. Note how the left and right sides 170 and 175 feature cut outs 180 and 185 that match up at either side of the centerline 20. Creating the stencil in two structurally intact halves, which combine in application to create a cohesive whole, eliminates the possibility of a loss of stencil design integrity when applied to a corner surface. Such a dilemma commonly occurs when a person skilled in the art, or other artist, attempts to convert a running border stencil into a corner stencil by folding, cutting, creasing and/or otherwise distorting and conforming the stencil into a position bridging a wall corner 10 with centerline 20. Performing any of the activities referenced in the preceding sentence can result in lost, clipped and/or misshapen elements of the original stencil because it will not lie flat.

Although the embodiments of the stop-gap stencils (mirror images) 70 and 80 and base running border stencils extending therefrom on either side (mirror images) 150 and 160 are shown here in FIG. 4, this image is not to scale and inclusion of these elements are for demonstrative purposes only. Typically the wall corner stencil halves, the stop-gap stencils and the base/running border stencil will be separate pieces of the design series.

What is claimed is:

1. A stencil template for use in wall corners of architectural and furniture structures comprising:
a stencil template separated in halves of left and right sides which have cut-outs that match at the inside edges of each half (at a centerline such as a wall corner) for increased adhesability without distortion to wall surfaces having possible irregularities;

2. The stencil template of claim 1 wherein the left and right sides are symmetrical and match up at the inside edge of each half (at a centerline such as a wall corner) to complete the stencil design;

3. The stencil template of claim 1 wherein the left and right sides are asymmetrical and match up at the inner edge of each half (at a centerline such as a wall corner) to complete the stencil design;

4. Stencil templates for use on wall and/or near wall corners of architectural and furniture structures comprising:
two symmetrical and/or balanced stencil templates offset equidistantly from a centerline (such as a wall corner) which terminate and/or bookend a base/running border stencil design in order to create an aesthetic pause and/or transition between said base/running border design and a centerline (such as a wall corner);

5. The stencil templates contemplated in claims 1 and 4 used in a stencil design template series and/or kit;

6. The stencil template of claim 1 wherein there are a plurality of different stencil templates with differently arranged cut-outs, allowing for a plurality of multi-colored patterns and/or designs included in a kit;

7. The stencil templates of claim 4 wherein there are a plurality of different stencil templates with differently arranged cut-outs, allowing for a plurality of multi-colored patterns and/or designs included in a kit;

8. The stencil templates contemplated in claims 1 and 4 designed to compliment existing base/running border stencils created by persons skilled in the art included together in a series and/or kit;

9. The stencil templates contemplated in claims 1 and 4 with base/running border stencil templates designed to be used together and/or independently and sold in a series and/or kit.
